(19) United States
(12) Patent Application Publication
(10) Pub. No.: US 2007/0237316 A1
(43) Pub. Date: Oct. 11, 2007

(54) Remote control device and system for controlling a device

(75) Inventors: Hideki Tanabe, Daito-shi (JP); Yasuo Masaki, Daito-shi (JP); Yasunari Miyake, Daito-shi (JP); Hirono Tsubota, Daito-shi (JP); Masahiro Takeshita, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/728,740

(22) Filed: Mar. 27, 2007

(30) Foreign Application Priority Data
Mar. 27, 2006 (JP) 2006-084637

(51) Int. Cl. H04N 9/79; H04M 11/00

(52) U.S. Cl. 379/102.03; 340/825.72; 398/106; 348/734; 386/35

(57) ABSTRACT

A remote control device capable of controlling devices in an expanded range is provided. Processing executed by a remote control includes the steps of transmitting a control signal to an HDD recorder, transmitting a communications request to a remote control connected over the Internet based on a reply received from the HDD recorder, and executing an IP telephone session to/from the remote control. The IP telephone session includes the steps of transmitting control information for controlling an operation of the HDD recorder based on a reply provided from the remote control, receiving a reply of a result of determination about control information from the remote control, and transmitting a request for the control to the remote control based on the reply.

### BACKGROUND OF THE INVENTION

1. Field of the Invention

The present invention relates to control of a device or equipment, and particularly to a remote control device that can control a device over a network as well as a system for controlling a device.

2. Description of the Background Art

A technique for remotely controlling a device arranged in a home is known. For example, Japanese Patent Laying-Open No. 2004-187149 has disclosed a technique that can reduce processing for performing access away from a home as far as possible, and can safely control the processing.

For example, as a technique for externally monitoring operation states of various devices, Japanese Patent Laying-Open No. 2004-295873 has disclosed a remote control system that can detect operation states of various devices in real time over the Internet.

When recording a television program at a home, such a situation may occur that a storage capacity of an HDD (Hard Disk Drive) recorder or another recording device becomes full, and can no longer record the program. For example, a user cannot perform his/her intended programming for recording in some cases. The user of the recorder may first find that the programmed recording is impossible, only when a sufficient time is not left before a start of intended recording. In this case, the user must discard existing contents, e.g., by erasing recorded data. Alternatively, the user may ask a friend or the like by telephone to perform the programmed recording for the user. When the friend or the like is not at home, the programmed recording for the user cannot be performed, and the recording desired by the user cannot be performed.

### SUMMARY OF THE INVENTION

The invention has been made for overcoming the above problems, and it is an object of the invention to provide a remote control that can expand a controllable range of a device.

Another object of the invention is to provide a remote control that can control a device arranged outside a home.

For achieving the above objects, an aspect of the invention provides a remote control device that can control a first device capable of recording and reproducing a movie. The remote control device includes: an IP telephone unit performing communications over a network with a different remote control device connected to the network according to an Internet protocol; and a storage storing access data used for connection to the different remote control device, address data for determining a position of the remote control device on the communications line, first control data for causing the first device to perform a predefined first operation, and second control data causing a second device being controllable by the different remote control device to perform a predefined second operation. The second device can record and reproduce the movie. The remote control device includes: an infrared ray emitter emitting an instruction based on the first control data; an input unit accepting entry of an instruction for causing the first device to perform the first operation; a determining unit determining whether the first device can execute the first operation or not; a session control unit establishing communications between the remote control device and the different remote control device, using the address data and the access data when the determining unit determines that the first operation cannot be executed; a generating unit generating a request signal requesting the second device to execute, as the second operation, an operation corresponding to the first operation based on the second control data; and a transmission controller causing the IP telephone unit to transmit the request signal to the different remote control device.

According to another aspect, the invention provides a remote control device controlling a first control target device. This remote control device includes a communications unit performing communications over a communications line with a different remote control device connected to the communications line; a storage storing address data for determining a position of the remote control device on the communications line, access data used for connection to the different remote control device, first control data for causing the first control target device to execute a first operation, and a second control data for causing a second control target device controllable by the different remote control device to execute a second operation; an output unit providing an instruction based on the first control data; an input unit accepting entry of the instruction; a session control unit establishing communications between the remote control device and the different remote control device based on the instruction, using the address data and the access data; and a controller controlling the operation of the second control target device based on the second control data.

According to still another aspect, the invention provides a system for controlling a device. The system includes a first control target device, and a remote control device controlling the first control target device. This remote control device includes: a communications unit performing communications over a communications line with a different remote control device connected to the communications line; a storage storing address data for determining a position of the remote control device on the communications line, access data used for connection to the different remote control device, first control data for causing the first control target device to execute a first operation, and second control data for causing a second control target device controllable by the different remote control device to execute a second operation; an output unit providing an instruction based on the first control data; an input unit accepting entry of the instruction; a session control unit establishing communications between the remote control device and the different remote control device based on the instruction, using the address data and the access data; and a controller controlling the operation of the second control target device based on the second control data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a home network 10 formed of equipment controlled by a remote control 100, and a structure of a home network 20 formed of equipment controlled by remote control 100 having similar functions.

FIG. 2 illustrates a flow of a process of establishing communications session between remote controls 100 and 102 and HDD recorders 110 and 112.

FIG. 3 shows an external appearance of remote control 100.

FIG. 4 is a block diagram illustrating a configuration of functions achieved by remote control 100.

FIG. 5 conceptually illustrates a form of data storage in a storage 410.

FIG. 6 illustrates data stored in storage 410 by remote control 100 for controlling an HDD recorder 110.

FIG. 7 is a block diagram illustrating a hardware structure of HDD recorder 110.

FIG. 8 is a block diagram illustrating a configuration of functions executed by a CPU 710.

FIG. 9 is a block diagram illustrating a hardware structure of an HDD recorder 112.

FIG. 10 is a block diagram illustrating a configuration of functions of remote control 102.

FIG. 11 conceptually illustrates a form of data storage in a storage 1030 provided in remote control 102.

FIG. 12 conceptually illustrates a form of storage of data for controlling a device in storage 1030.

FIG. 13 is a flowchart illustrating a procedure of processes executed by remote control 100.

FIG. 14 is a flowchart illustrating a procedure of processes executed by a CPU 1050 of remote control 102.

FIG. 15 is a flowchart illustrating a procedure of processes executed by a CPU 910 of HDD recorder 112.

FIG. 16 conceptually illustrates a structure of a packet 1600 transmitted from remote control 100 to remote control 102.

FIG. 17 conceptually illustrates a structure of a control signal 1700 transmitted from remote control 102.

FIG. 18 conceptually illustrates a structure of a reply signal 1800 transmitted from HDD recorder 112.

FIG. 19 conceptually illustrates a structure of a packet 1900 transmitted from remote control 102 to remote control 100.

FIG. 20 conceptually illustrates a structure of a packet 2000 transmitted from remote control 100 to remote control 102.

FIG. 21 conceptually illustrates a structure of a packet 2100 transmitted from remote control 100 according to a first modification.

FIG. 22 conceptually illustrates a structure of a packet 2100 transmitted from remote control 100 to remote control 102 according to a second modification.

### DESCRIPTION OF THE PREFERRED EMBODIMENTS

Embodiments of the invention will now be described with reference to the drawings. In the following description, the same parts or portions bear the same reference numbers and the same names, and achieve the same functions. Therefore, description thereof is not repeated.

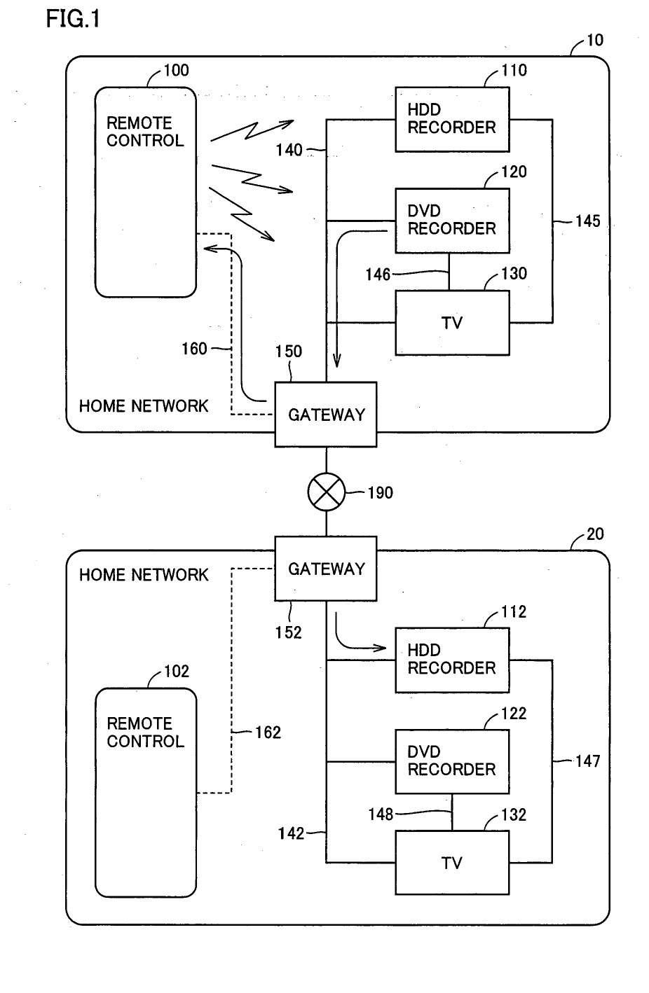

Referring to FIG. 1, description will now be given on a form of use of a remote control 100 according to an embodiment of the invention. FIG. 1 shows a structure of a home network 10 formed of equipment controlled by a remote control 100 as well as a structure of a home network 20 formed of equipment controlled by remote control 100 having similar functions. Remote control 100 can be used for controlling operations of a television set, VTR (Video Tape Recorder), HDD recorder, DVD (Digital Versatile Disk) player, DVD recorder, PC (Personal Computer), air conditioner, lighting fixture and other home electric appliances.

Home network 10 includes remote control 100, an HDD recorder 110, a DVD recorder 120, a television set 130, and a gateway 150. A wireless communications network 160 connects remote control 100 to gateway 150. A network 140 connects HDD recorder 110, DVD recorder 120, television set 130, and gateway 150 together. A cable 145 connects HDD recorder 110 to television set 130. A cable 145 connects DVD recorder 120 to television set 130. Gateway 150 is connected to Internet 190.

Home network 20 includes a remote control 102, a HDD recorder 112, a DVD recorder 122, a television set 132, and a gateway 152. A radio communications network 162 connects remote control 102 to gateway 152. Network 142 connects HDD recorder 112, DVD recorder 122, television set 132 and gateway 152 together. A cable 147 connects HDD recorder 112 to television set 132. A cable 148 connects DVD recorder 122 to television set 132.

Remote control 100 can individually control HDD recorder 110, DVD recorder 120 and television set 130. The control of each device is achieved by changing relationships between control data stored in remote control 100 and control target devices. Specific structures of remote control 100 will be described later.

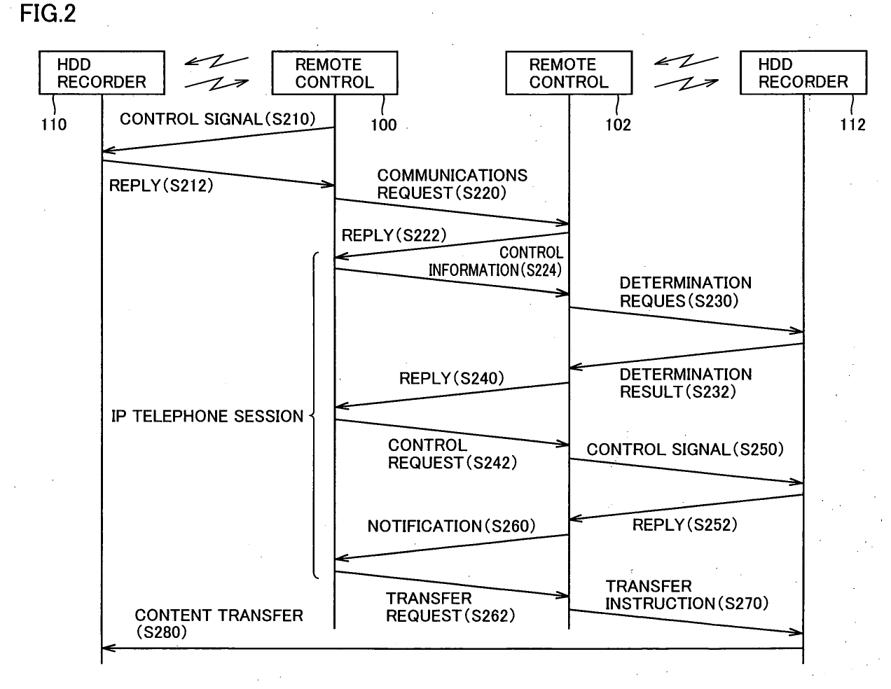

Referring to FIG. 2, description will now be given on a form or manner of communications between home networks 10 and 20. FIG. 2 illustrates a flow of a process of establishing communications session between remote controls 100 and 102 and HDD recorders 110 and 112. This communications session is established according to a protocol for achieving the IP telephone.

In step S210, remote control 100 provides a control signal to HDD recorder 110 based on a user's operation. This control signal is, e.g., a signal for executing programmed recording at a preselected time. When HDD recorder 110 receives this control signal, it determines whether HDD recorder 110 can perform the recording at the preselected time or not.

In step S212, HDD recorder 110 transmits a reply to remote control 100 for responding to an instruction specified by the control signal. HDD recorder 110 is provided, e.g., at a front surface of its casing with a light emitter that can emit the control signal. The control signal emitted therefrom has a predetermined directivity so that remote control 100 located within a range thereof can receive the signal transmitted from HDD recorder 110. When remote control 100 receives the signal, it obtains information included therein, and determines whether the instruction transmitted as the control signal can be executed or not. When it determines that the instruction cannot be executed, remote control 100 starts communications with home network 20.

More specifically, in step S220, remote control 100 transmits a communications request for starting communications to remote control 102 based on access data registered in advance. Since remote control 102 has a function of communications over the network, it can receive the communications request from remote control 100. Remote control 102 obtains information included in the communications request, and produces a reply to the information.

In step S222, remote control 102 transmits the reply to the communications request to remote control 100 over Internet 190. When this reply represents that the communications between remote controls 100 and 102 can be performed, the IP telephone session is established, and then the IP communications can be performed.

In step S224, remote control 100 transmits control information to remote control 102 over Internet 190. The control information has details or descriptions that are included in the control signal transmitted to HDD recorder 110 in step S210. Remote control 102 obtains the control information provided from remote control 100, and stores the information by writing it into an internal memory.

In step S230, remote control 102 transmits a request to HDD recorder 112 for determining whether programmed recording can be performed based on the information transmitted from remote control 100. Based on this request, HDD recorder 112 refers to the internally stored data, and determines whether the requested recording can be executed or not. HDD recorder 112 has a function of transmitting a signal, similarly to HDD recorder 110. Therefore, HDD recorder 112 transmits a result of the determination. Thus, in step S232, HDD recorder 112 transmits an infrared signal including the result of determination to a predetermined range. When remote control 102 receives the infrared signal, it converts it into a signal for communications over Internet 190.

In subsequent step S240, remote control 102 transmits the result of determination by HDD recorder 112 to remote control 100 as a reply. When the result of determination represents, e.g., that HDD recorder 112 can perform the programmed recording requested by remote control 100, remote control 100 converts the information having substantially the same details as the control signal that was initially transmitted to HDD recorder 110 into information for network communications. In step S242, remote control 100 transmits packet data produced by the conversion to remote control 102 as a control request for the programmed recording.

In step S250, remote control 102 converts the packet data received from remote control 100 into an infrared signal, and transmits it as a control signal instructing the programmed recording. When HDD recorder 112 receives the control signal transmitted from remote control 102, it refers to information included in the received signal, and stores data for the programmed recording in the memory. More specifically, HDD recorder 112 writes date and time of start of the recording, a time length of recording and a channel in a predetermined memory area. In step S252, HDD recorder 112 transmits, as an infrared signal, a reply representing that the setting of the programmed recording is completed. In step S260, remote control 102 converts this reply into data for the network transmission in response to the reception thereof, and notifies remote control 100 of the completion of the programmed recording.

When the time indicated by remote control 100 comes thereafter, HDD recorder 112 reads channel information stored therein, calls up the channel and starts the recording in a preset record mode. When an end time indicated by the control signal comes, HDD recorder 112 ends the recording. When the recording is completed, HDD recorder 112 produces a signal including the information representing the completion of the recording, and transmits the produced signal from the light emitter arranged at the casing. When remote control 102 receives the signal, it converts the signal into data representing the completion of the instructed recording, and transmits it to remote control 100 over Internet 190.

This data is written into the memory of remote control 100, and a display, LED or another notifying unit arranged in remote control 100 operates to notify of completion of the recording. This operation includes display of letters, icon image and the like on the display, and/or includes turn-on, flashing or the like of the LED.

When a user of remote control 100 enters an instruction for data transfer, remote control 100 transmits data requesting the transfer of contents recorded by the programmed recording to remote control 102 in step S262. When remote control 102 receives the data, it provides a transfer instruction to HDD recorder 112 to read and transfer the recorded contents over the network. When HDD recorder 112 receives the instruction, it refers to an address of a hard disk, reads the data of the contents recorded by the programmed recording and starts transmission thereof to HDD recorder 110 over network 142.

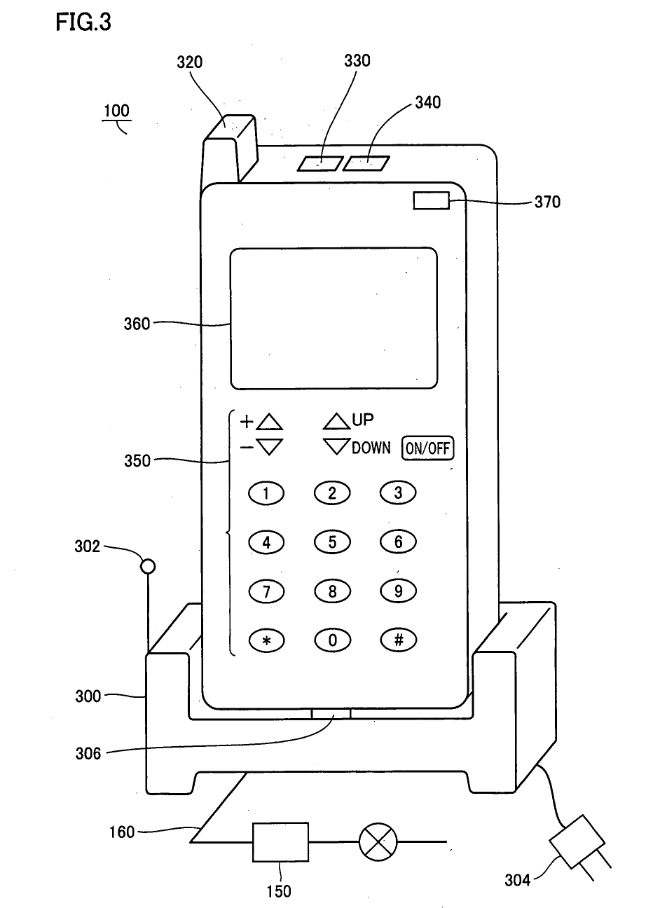

Referring to FIG. 3, a structure of remote control 100 will now be described. FIG. 3 shows an outer appearance of remote control 100. Remote control 100 includes an antenna 320 for radio communications, a light emitter 330 emitting infrared signals, a light receiver 340 receiving infrared signals, a plurality of operation buttons 350 accepting entry of instructions, a display 360 displaying characters and an LED 370 emitting light in a predefined color.

Remote control 100 is arranged on a cradle 300, e.g., having a charging function. Cradle 300 includes an antenna 302 receiving radio signals transmitted from antenna 320 of remote control 100, a charging connector 306 supplying a power to remote control 100 and a connector 304 for obtaining a power supply. Cradle 300 is connected to gateway 150. Cradle 300 may be configured to function as gateway 150 in another situation.

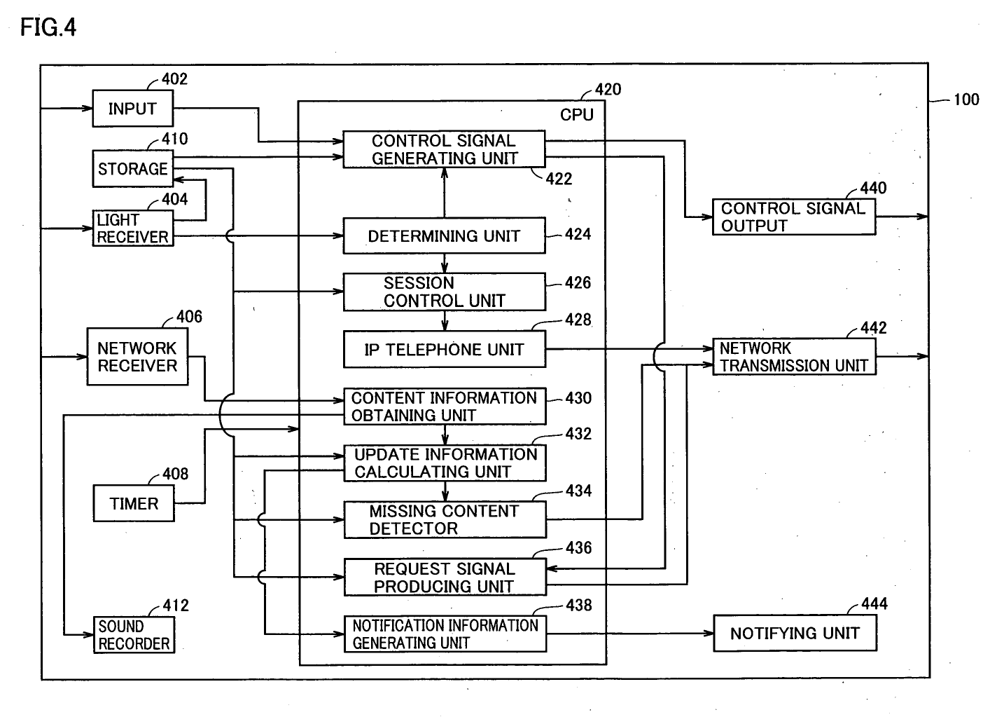

Referring to FIG. 4, the structure of remote control 100 is further described. FIG. 4 is a block diagram illustrating a configuration of functions achieved by remote control 100. Remote control 100 includes an input 402, a light receiver 404, a network receiver 406, a timer 408, a storage 410, a sound recorder 412, a controller 420, a control signal output 440, a network transmission unit 442 and a notifying unit 444.

Controller 420 includes a control signal generating unit 422, a determining unit 424, a session control unit 426, an IP telephone unit 428, a content information obtaining unit 430, an update information calculating unit 432, a missing contents detector 434, a request signal producing unit 436 and a notification information generating unit 438.

Input 402 accepts entry of an operation on remote control 100. For example, input 402 is achieved by buttons 350 shown in FIG. 3. The instruction for the operation accepted by input 402 is sent to control signal generating unit 422.

Light receiver 404 receives the infrared signal. For example, light receiver 404 corresponds to light receiver 340 shown in FIG. 3. Light receiver 404 can receive control signals transmitted from various devices or units as they are. Since the infrared signal contains device codes and manufacturer codes for identifying the device, remote control 100 refers to the codes, and thereby can function as a device for controlling the device (control target device) that is a source or sender of the received control signal.

Network receiver 406 receives packet data transmitted from gateway 150. Network receiver 406 transmits the received data to content information obtaining unit 430. Network receiver 406 takes the form, e.g., of the interface that can perform radio communications.

Timer 408 obtains time (time of day) information in remote control 100, and transmits it to controller 420. Recorder 412 stores audio signals transmitted from controller 420. Recorder 412 can be achieved, e.g., by a flash memory that can nonvolatilely store the data.

Storage 410 stores the data for identifying remote control 100 as well as control data for providing an instruction to a control target device. Storage 410 is achieved, e.g., by a flash memory.

Control signal generating unit 422 produces control signals for controlling the device based on the instruction provided from input 402 and the data stored in storage 410. Control signal generating unit 422 sends the signal produced thereby to control signal output 440. When an instruction to the device that can be controlled by remote control 100 is not achieved, control signal generating unit 422 produces a signal for performing communications with another remote control. More specifically, based on a signal provided from determining unit 424 to be described below, control signal generating unit 422 produces a request signal for determining whether the instruction to another device is executable or not.

Based on the signal sent from light receiver 404, determining unit 424 determines whether the processing is allowed in a control target device of remote control 100. More specifically, light receiver 404 receives an infrared signal from the control target device. This signal contains data representing whether the target device can execute the operation instructed by remote control 100 or not. Based on this data, determining unit 424 determines whether the operation for the signal provided from remote control 100 can be executed or not, and sends the data representing a result of the determination to control signal generating unit 422. Based on the signal sent from determining unit 424, control signal generating unit 422 sends to request signal producing unit 436 a request for transmitting the foregoing signal to another remote control.

Based on the result of determination by determining unit 424 and the data stored in storage unit 410, session control unit 426 executes control of the session for communications with another remote control (e.g., remote control 102). More specifically, session control unit 426 refers to an access code of remote control 102 stored in storage 410 and data (e.g., a password) for accessing Internet 190, and executes the processing for starting the communications with remote control 102 over Internet 190. When session control unit 426 confirms the establishment of the session, it sends an instruction to IP telephone unit 428 to execute the communications based on the Internet protocol. IP telephone unit 428 starts the communications over Internet 190 based on the instruction provided from session control unit 426. Thereby, the communications between remote controls 100 and 102 are achieved in the peer-to-peer fashion.

Content information obtaining unit 430 obtains information of the contents stored in another device from the packet data received by network receiver 406. For example, content information obtaining unit 430 obtains a list of titles of the record data stored in devices controlled by remote control 102, i.e., HDD recorder 112, DVD recorder 122 and others. Content information obtaining unit 430 sends the obtained information to update information calculating unit 432. Update information calculating unit 432 compares the content information stored in storage 410 with the content information transmitted from content information obtaining unit 430, and obtains information representing whether the stored contents are updated on home network 20 or not. More specifically, when it is determined that a new program has been recorded, a flag indicating new contents is assigned to the title of this new program. Conversely, when it is determined that the contents stored in storage 410 are already deleted, update information calculating unit 432 assigns a flag indicating deletion of the contents in question on home network 20 to the data registered in storage 410.

Alternatively, update information calculating unit 432 detects a difference between the contents stored in home network 10 and the contents stored on home network 10. Update information calculating unit 432 sends a result of the detection to missing contents detector 434.

Based on the above result, missing contents detector 434 produces a request for transmitting the contents stored on another home network such as home network 20, and sends the request to network transmission unit 442. This signal for request includes, in addition to, e.g., the address of home network 20, a title of the contents to be transferred and a device (e.g., data identifying HDD recorder 112) storing the contents in question.

When the above signal is transmitted to Internet 190 over network transmission unit 442, home network 20 is controlled based on data of the transmitted signal to transmit the contents, e.g., to HDD recorder 110 of home network 10. When HDD recorder 110 stores the contents, it transmits an infrared signal representing the completion of the transfer of contents. When remote control 100 receives the infrared signal, the data representing the list of contents in HDD recorder 110 is updated in storage 410.

After the update, update information calculating unit 432 refers to the data of storage 410, and detects that contents was added to HDD recorder 110. When update information calculating unit 432 detects this update, the data representing the added contents is transmitted to notification information generating unit 438. Based on the received information, notification information generating unit 438 produces data for notifying the user of remote control 100 of the addition of the contents. When this data is transmitted to notifying unit 444, notifying unit 444 executes the predefined notifying operation.

Notifying unit 444 is, e.g., display 360, LED 370 or a speaker (not shown) arranged at remote control 100. For example, display 360 displays a message representing the completion of the predefined operation. LED 370 flashes at preset intervals in a predetermined color. The speaker plays a sound predefined as a sound to be played at the time of completion of the operation, based on the sound data prestored in remote control 100.

Control signal output 440 externally provides a signal for controlling a device based on the signal provided from controller 420. Control signal output 440 is achieved by light emitter 330. In this case, control signal output 440 transmits an infrared signal having a preset frequency.

Network transmission unit 442 can transmit packet data. Network transmission unit 442 is achieved, e.g., by antenna 320 and a transmission interface (not shown).

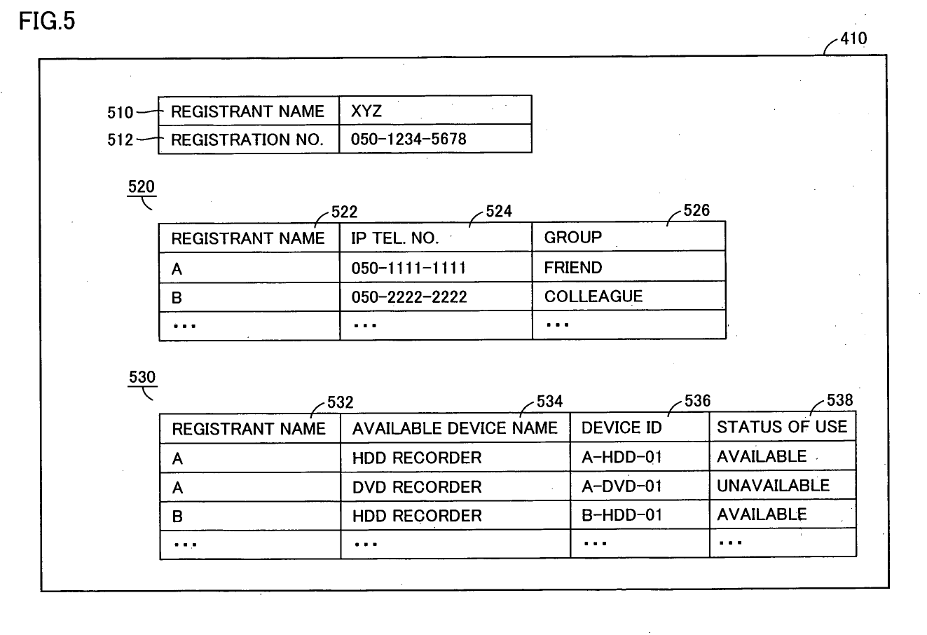

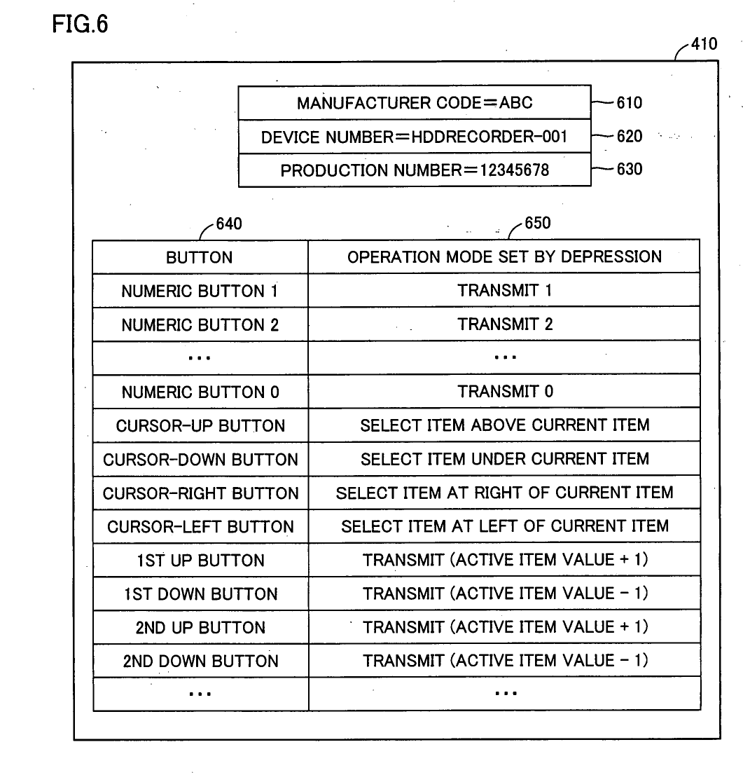

Referring to FIGS. 5 and 6, the data structure of remote control 100 will now be described. FIG. 5 conceptually illustrates a form of the data storage in storage 410. Storage 410 includes a registrant name 510 representing the user of remote control 100, and a registration number 512 assigned in advance for performing the IP connection by remote control 100. Registrant name 510 is data that is registered by entering character information allowing identification of the user, e.g., by the operations on buttons 350. Registration number 512 is a telephone number that is assigned by a communications business corporation when remote control 100 is connected to home network 10.

Storage 410 further includes tables 520 and 530. Table 520 includes registrant names 522, IP telephone numbers 524 and groups 526. Registrant name 522 corresponds to a communication party on the other end that was entered in advance by the user for performing the IP communications by remote control 100. IP telephone number 524 is assigned in advance to each registrant for the IP communications. Group 526 is attribute information specifying the group containing each registrant bearing registrant name 522. By referring to the attribute information such as group 526, it is possible, e.g., to perform the content transfer in a simple and appropriate manner between users having the same features such as taste, hobby or the like. From the viewpoint of protection of the copyright relating to digital contents, such a structure may be employed that a control signal, e.g., allowing the transfer only once is added to the content signal, and this control signal inhibits the further transfer of the received contents from the recording device on the receiver side.

Table 530 includes registrant names 532, available device names 534, device IDs 536 and use situations 538. Registrant name 532 is the same as registrant name 522 in table 520. Available device name 534 represents, for each registrant, a device for which remote control 100 can be used on the home network of the registrant. Device ID 536 is data for identifying the device in question by remote control 100 related to this device. Use situation 538 represents whether the device in question is currently available or not. The data stored in tables 520 and 530 can be successively updated by the user's operation on buttons 350, or by obtaining the information from another remote control via network receiver 406.

FIG. 6 represents the data that is stored in storage 410 of remote control 100 for controlling HDD recorder 110. In addition to data items illustrated in FIG. 5, storage 410 includes a manufacturer code 610, a device number 620, a production number 630, buttons 640 and operation modes 650. Manufacturer code 610 is data representing a manufacturer of HDD recorder 110. Device number 620 is a production code for identifying HDD recorder 110. Production number 630 is uniquely assigned to HDD recorder 110. Manufacturer code 610, device number 620 and production number 630 are obtained from HDD recorder 110 by communications between remote control 100 and HDD recorder 110. The user of remote control 100 may operate buttons 350 to enter the respective data items. When storage 410 stores these data items, remote control 100 functions as a remote control for controlling HDD recorder 110.

In another situation, the user of remote control 100 may stores information of another device (e.g., DVD recorder 120 or television set 130) in storage 410. In this case, remote control 100 will function as a remote control for controlling the device that is set after the updating. Also, instead of the structure of successively obtaining the information of the devices, such a configuration may be employed that a plurality of tables are prepared in advance, and the tables store the information of the devices, respectively. In this case, the user operates buttons 350 on remote control 100 to select the device to be controlled, and thereby can achieve a situation for controlling only the selected device.

Referring to FIG. 6 again, storage 410 has data for identifying each of buttons 350 as well as data indicating the operations to be executed in response to respective operations on the buttons.

More specifically, area 640 stores data for identifying the respective buttons. Area 650 stores the operation modes for indicating the functions assigned to the respective buttons. For example, a numeric button “1” is assigned a function for transmitting a signal indicative of “1” when it is depressed. A cursor-up button is assigned a function of selecting an item located above a current item displayed on display 360, or a function of providing an instruction for selecting an item located above a current item displayed on a screen of television set 130 when remote control 100 is controlling television set 130.

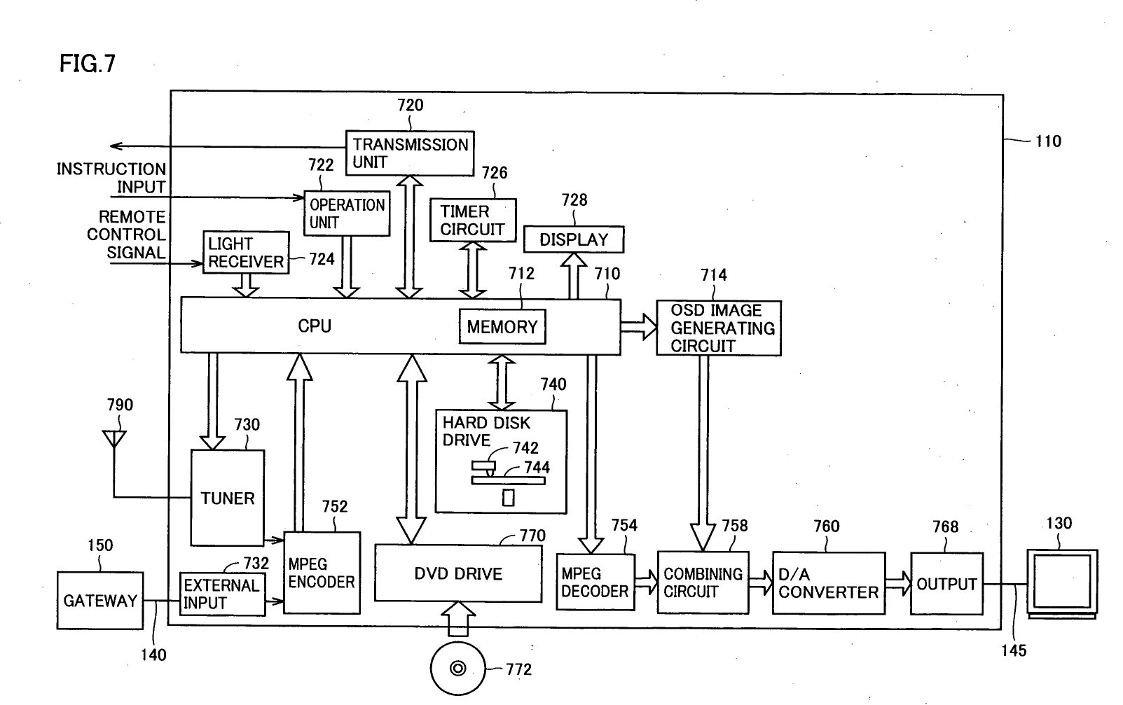

Referring to FIG. 7, HDD recorder 110 according to the embodiment will now be described. FIG. 7 is a block diagram illustrating a hardware structure of HDD recorder 110. HDD recorder 110 is connected to television set 130 via cable 145. HDD recorder 110 is connected to gateway 150 over network 140.

HDD recorder 110 includes a light receiver 724 receiving a remote control signal, an operating unit 722 accepting entry of an instruction and a transmitting unit 720 transmitting an infrared signal. Further, HDD recorder 110 includes a tuner 730 connected to an antenna 790, an external input 732, an MPEG (Moving Picture Experts Group) encoder 752, a timer circuit 726, a display unit 728, a CPU 710, a memory 712, a DVD drive 770, a hard disk drive 740, an MPEG decoder 754, an OSD (On Screen Display) image generating circuit 714, a combining circuit 758, a D/A (Digital to Analog) converter 760 and an output 768.

Hard disk drive 740 has a hard disk 744 recording digital information, and a pickup 742 for writing data onto hard disk 744 or reading data therefrom. DVD drive 770 can be loaded with a DVD 772.

Light receiver 724 receives a control signal such as an infrared signal transmitted from a remote control terminal. The control signal transmitted from the remote control and accepted by light receiver 724 is sent to CPU 710. Operating unit 722 is achieved, e.g., by a touch panel or buttons. Operating unit 722 converts the accepted instruction into an electric signal, and sends it to CPU 710. Signal transmitting unit 720 produces an infrared signal based on the signal produced by CPU 710, and transmits it to a predefined range. This range depends on forms of output and attachment of the light emitting element. The infrared signal includes a reply to the control signal received by light receiver 724. This reply includes information about whether the programmed recording is allowed or not.

Timer circuit 726 produces time information in HDD recorder 110, and sends it to CPU 710. Timer circuit 726, which is an independent circuit element, may alternatively be included in CPU 710.

Display unit 728 displays information representing an operation state of HDD recorder 110 based on the data produced by CPU 710. Display unit 728 is achieved by an LCD, an organic EL (Electro-Luminescence) or the like. The operation state includes states such as a state in which HDD recorder 110 accepted the externally provided contents, and has written data of the accepted contents onto hard disk 744. For example, display unit 728 is practically an LCD provided at a casing.

Antenna 790 receives television broadcast signals. The signals received by antenna 790 are provided to tuner 730. Based on the tuning instruction by CPU 710, tuner 730 obtains radio waves of the channel to be selected, and sends them to MPEG encoder 752. MPEG encoder 752 can also receive the signal provided from external input 732. MPEG encoder 752 performs compression and encoding on the signal provided from tuner 730 or the signal accepted via external input 732, and outputs the encoded signal. Hard disk drive 740 writes the compressed and encoded signal into an area reserved on hard disk 744.

MPEG decoder 754 decodes and outputs the data stored on hard disk 744 based on the instruction of CPU 710. This signal is sent to combining circuit 758. Based on the instruction provided from light receiver 724 or the operation effected on operating unit 722, CPU 710 provides an instruction for producing an image (e.g., a channel number) to be displayed on television set 130. This instruction is sent to OSD image generating circuit 714. Based on this instruction, OSD image generating circuit 714 produces data for displaying characters, and sends it to combining circuit 758.

Combining circuit 758 produces a digital signal of an image to be displayed on television set 130 based on the data provided from MPEG decoder 754 and the data provided from OSD image generating circuit 714. This signal is sent to D/A converter 760, which converts the digital signal into an analog signal, and outputs it. Output 768 externally outputs the signal via cable 145. When television set 130 receives the provided signal, it displays an image based on the data stored on hard disk 744. If television set 130 accepts the input of the digital signal, D/A converter 760 can be eliminated.

DVD drive 770 reads the data stored on loaded DVD 772 according to the instruction provided from CPU 710, and provides it to MPEG decoder 754. Alternatively, CPU 710 sends an instruction signal to DVD drive 770 to write the signal obtained by tuner 730 or the signal provided to external input 732. Based on the instruction signal, DVD drive 770 writes the data onto DVD 772 in a preset record mode.

The operations achieved by HDD recorder 110 will be easily understood by those skilled in the art, and therefore description thereof is not repeated.

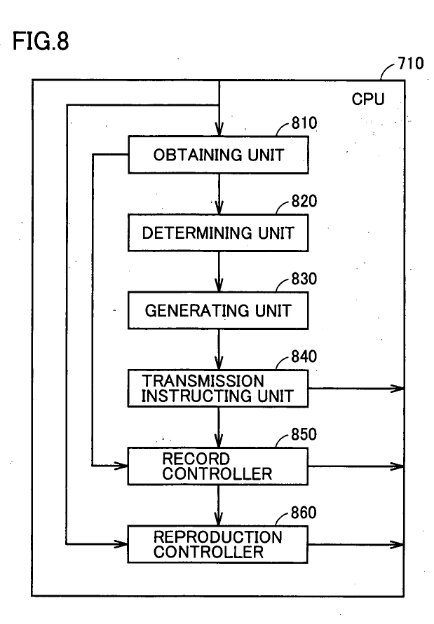

Referring to FIG. 8, description will now be given on the function achieved by HDD recorder 110. FIG. 8 is a block diagram illustrating a configuration of functions realized by CPU 710. CPU 710 includes a programmed recording information obtaining unit 810 for obtaining information that instructs programmed recording based on the externally provided information, a determination unit 820 for determining whether the programmed recording can be executed or not, a generating unit 830 producing data that represents a result of the determination, a transmission instructing unit 840 that transmits the instruction produced by generating unit 830, a record controller 850 sending the instruction to various units to perform the recording based on the provided instruction, and a reproduction controller 860 sending an instruction signal to hard disk drive 740 to reproduce the contents selected based on the provided instruction.

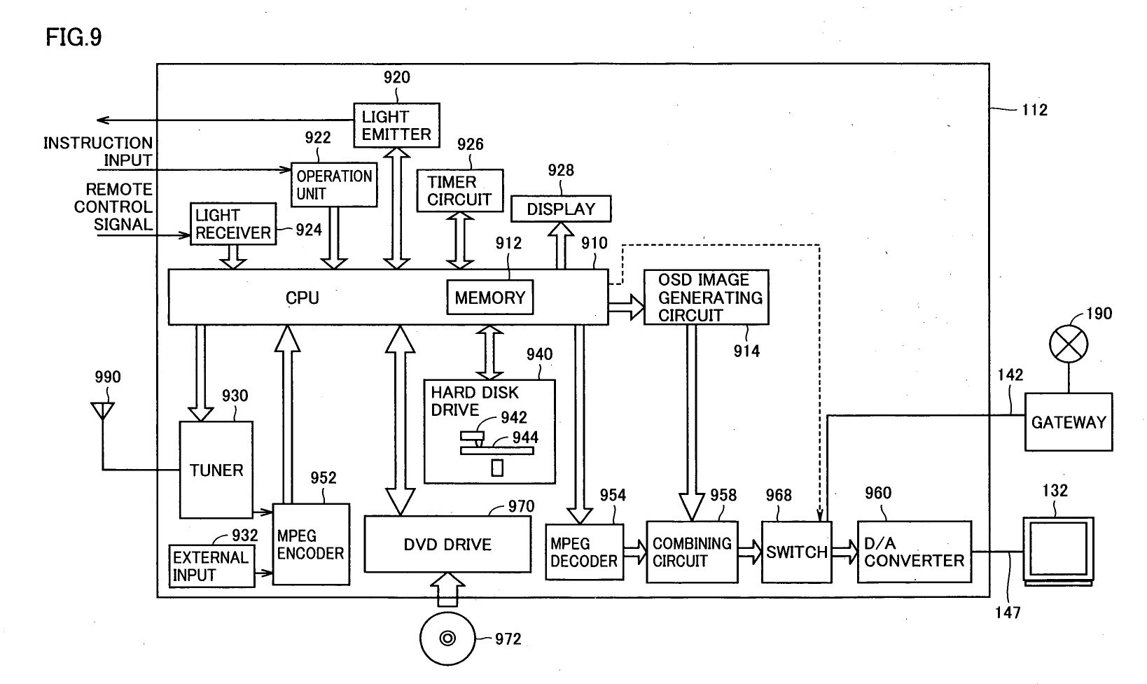

Referring to FIG. 9, description will now be given on HDD recorder 112 forming home network 20. FIG. 9 is a block diagram illustrating the hardware structure of HDD recorder 112.

HDD recorder 112 includes a light receiver 924 receiving a remote control signal, an operating unit 922 accepting entry of instructions, and a light emitter 920 emitting an infrared signal. HDD recorder 112 further includes a tuner 930 connected to an antenna 990, an external input 932, MPEG encoder 752, a timer circuit 926, a display unit 928, a CPU 910, a memory 912, a DVD drive 970, a hard disk drive 940, an MPEG decoder 954, an OSD (On Screen Display) image generating circuit 914, a combining circuit 958, a D/A (Digital to Analog) converter 960 and an output selector 968.

Hard disk drive 940 includes a hard disk 944 storing digital information, and a pickup 942 writing data on hard disk 944 and reading data therefrom. DVD drive 970 can be loaded with a DVD 972

The control signal provided from the remote control and accepted by light receiver 924 is provided to CPU 910. Operation unit 922 is achieved, e.g., by a touch panel or buttons. Operating unit 922 likewise converts the accepted instruction into an electric signal, and sends it to CPU 910. Light emitter 920 produces an infrared signal based on the signal produced by CPU 910, and emits it to a predefined range. The infrared signal includes a reply to the control signal received by light receiver 924. This reply includes information about whether the programmed recording is allowed or not.

Timer circuit 926 produces time information in HDD recorder 112, and sends it to CPU 910. Display unit 928 displays information representing an operation state of HDD recorder 112 based on the data produced by CPU 910. The operation state includes states such as a state in which HDD recorder 112 accepted the externally provided contents, and has written data of the accepted contents onto hard disk 944. For example, display unit 928 is practically an LCD provided at a casing.

Antenna 990 receives television broadcast signals. The signals received by antenna 990 are provided to tuner 930. Based on the tuning instruction by CPU 910, tuner 930 obtains radio waves of the channel to be selected, and sends them to MPEG encoder 952. MPEG encoder 952 can also receive the signal provided from external input 932. MPEG encoder 952 performs compression and encoding on the signal provided from tuner 930 or the signal accepted via external input 932.

Hard disk drive 940 writes the compressed and encoded signal into an area reserved on hard disk 944.

MPEG decoder 954 decodes and outputs the data stored on hard disk 944 based on the instruction of CPU 910. This signal is sent to combining circuit 958. Based on the instruction provided from light receiver 924 or the operation effected on operating unit 922, CPU 910 provides an instruction for producing an image (e.g., a channel number) to be displayed on television set 130. This instruction is sent to OSD image generating circuit 914. Based on this instruction, OSD image generating circuit 914 produces data for displaying characters, and sends it to combining circuit 958.

Combining circuit 958 produces a digital signal of an image to be displayed on television set 132 based on the data provided from MPEG decoder 954 and the data provided from OSD image generating circuit 914.

This signal is sent to an output selector 968 connected to network 142. Output selector 968 selects a destination of the audio and video signals from between television set 132 and network 142 based on a selection instruction provided from CPU 910.

More specifically, based on the control signal provided from remote control 102, CPU 910 reads contents stored in hard disk drive 940, and sends an instruction to output selector 968 to transmit the contents to network 142.

Based on the instruction thus sent, output selector 968 converts a data format of the contents in question into a data format for the Internet communications, and provides it to network 142. Thereby, the contents stored in HDD recorder 112 are transferred to HDD recorder 110 via Internet 190.

When the instruction provided from CPU 910 indicates provision of the contents to television set 132, the digital signal provided from combining circuit 958 is sent to D/A converter 960. D/A converter 960 converts the digital signal into the analog signal, and provides it to cable 147. Consequently, when television set 132 is in the state for accepting the signal provided from HDD recorder 112, television set 132 displays the image and plays the sound based on the content data stored in HDD recorder 112.

When television set 132 can accept the input of the digital signal, D/A converter 960 is not required, and HDD recorder 112 can output the digital data as it is.

DVD drive 970 reads the data stored on loaded DVD 972 according to the instruction provided from CPU 910, and provides it to MPEG decoder 954. Alternatively, CPU 910 sends an instruction signal to DVD drive 970 to write the signal obtained by tuner 930 or the signal provided to external input 932. Based on the instruction signal, DVD drive 970 writes the data onto DVD 972 in a preset record mode.

Further, HDD recorder 112 is connected to television set 132 via cable 147. HDD recorder 112 is connected to gateway 152 via network 142.

Specific operations of HDD recorder 112 illustrated in FIG. 9 are substantially the same as those of HDD recorder 110 illustrated in FIG. 7 except for the foregoing configurations and operations of the input and output. Details of them will be easily understood by those skilled in the art, and therefore description thereof is not repeated.

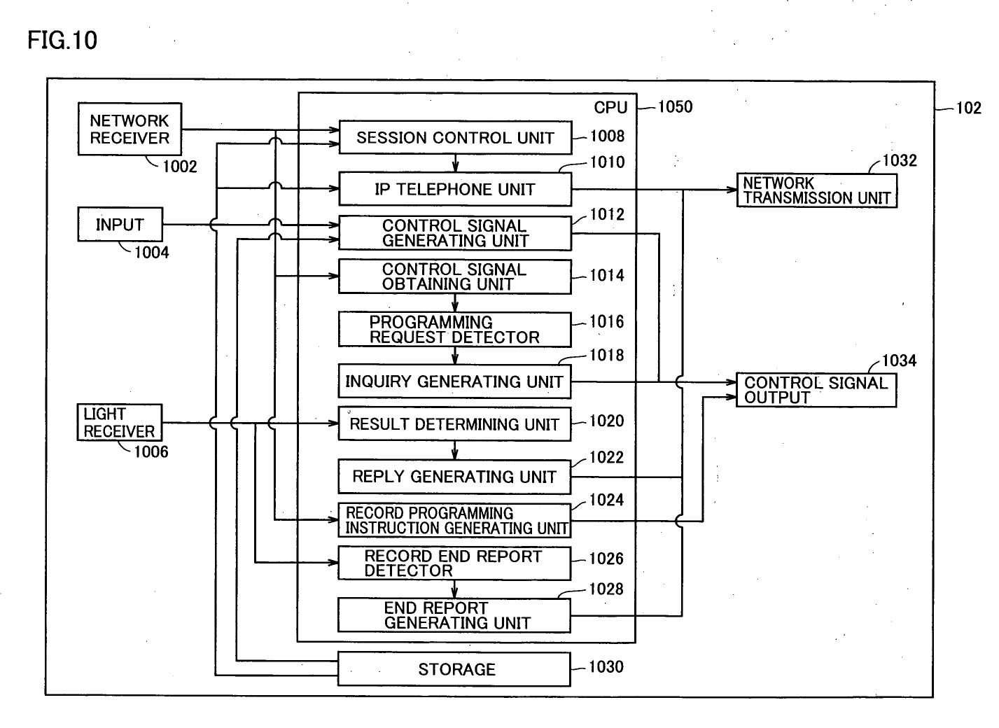

Referring to FIG. 10, description will now be given on remote control 102 used for controlling devices on network 20. FIG. 10 is a block diagram illustrating a configuration of functions of remote control 102. Remote control 102 includes a network receiver 1002, an input 1004, a light receiver 1006, a session control unit 1008, an IP telephone unit 1010, a control signal generating unit 1012, a control signal obtaining unit 1014, a programming request detector 1016, an inquiry signal generating unit 1018, a result determining unit 1020, a reply generating unit 1022, a programmed recording instruction generating unit 1024, a record end report detector 1026, an end report generating unit 1028, a storage 1030, a network transmission unit 1032 and a control signal output 1034.

Network receiver 1002 receives a signal transmitted from gateway 152 over radio communications network 162. Input 1004 accepts the entry of the instruction provided to remote control 102. Input 1004 is achieved, e.g., by buttons, a dial or another input mechanism arranged at remote control 102. Light receiver 1006 can receive infrared signals transmitted from various devices forming home network 20, i.e., HDD recorder 112, DVD recorder 122 and television set 132, respectively. The information included in the signals received by light receiver 1006 is sent to result determining unit 1020.

Session control unit 1008 controls the session for the communications with remote control 100 over Internet 190 based on the connection request that is included in the data received by network receiver 1002. More specifically, session control unit 1008 obtains the data for identifying remote control 100 from the data transmitted by remote control 100, and determines whether the obtained data matches with the data preregistered in storage 1030. When these data match, session control unit 1008 starts negotiation for establishing the communications with remote control 100. When the communications are established between remote controls 100 and 102, session control unit 1008 instructs IP telephone unit 1010 to perform the communications based on the Internet protocol.

Based on the data stored in storage 1030, IP telephone unit 1010 achieves the IP telephone function with respect to the party on the other end of the communications that are established by session control unit 1008. More specifically, IP telephone unit 1010 reads destination data stored in storage 1030, generates a packet including the read data and details of the data to be transmitted, and sends the packet to network transmission unit 1032.

Based on the instruction provided to input 1004, control signal generating unit 1012 generates the infrared signal for controlling the device, and sends it to control signal output 1034.

Control signal obtaining unit 1014 obtains the control signal transmitted by remote control 100 from the packet data received by network receiver 1002. More specifically, this control signal corresponds to the instruction (e.g., information for the programmed recording) transmitted from remote control 100 to HDD recorder 110. Control signal obtaining unit 1014 sends the obtained control signal to programming request detector 1016.

Programming request detector 1016 determines based on the received signal whether the signal transmitted from remote control 100 includes the programming request, i.e., the request for the programmed recording or not. This determination is performed, e.g., based on items of headers included in the transmitted packet. When programming request detector 1016 detects the programming request, it sends the result of this detection to inquiry signal generating unit 1018. Based on this detection result, inquiry signal generating unit 1018 generates a signal for inquiring whether or not the device that can be controlled by remote control 102 can be programmed for recording. Inquiry signal generating unit 1018 sends the generated signal to control signal output 1034. Control signal output 1034 converts this signal into an infrared signal, and emits it to a preset range.

Based on the signal of the device received by light receiver 1006, result determining unit 1020 determines the result indicating that the requested programming is allowed or not. More specifically, based on the control data included in the infrared signal transmitted from each device, result determining unit 1020 determines whether or not the recording can be performed in a preselected time period. The control data includes, as specific items, the time period in which the programmed recording is to be performed, the channel to be selected and data representing whether the programmed recording can be performed or not. Result determining unit 1020 sends the data representing the result of the determining to reply generating unit 1022.

Reply generating unit 1022 generates the data for replying to remote control 100 based on the data provided from result determining unit 1020. More specifically, reply generating unit 1022 generates packet data for the network transmission by preparing a header including an address of remote control 100 and preparing a body including data that represents details of the reply. Reply generating unit 1022 sends the data to network transmission unit 1032, which refers to the address included in the header thereof, and sends the packet data to remote control 100.

When remote control 100 transmits a firm instruction for the recording request based on the received reply, network receiver 1002 receives the data thus transmitted.

Programmed recording instruction generating unit 1024 extracts the data requesting the programmed recording from the packet data received by network receiver 1002 and produces, based on the extracted data, an instruction for programming the device included in home network 20. More specifically, programmed recording instruction generating unit 1024 produces the control signal including the start bit, the device code identifying the device to be programmed for recording, the control details (i.e., the time period of the programmed recording and the channel to be selected) and the end bit. Programmed recording instruction generating unit 1024 sends the generated control signal to control signal output 1034. Control signal output 1034 transmits this signal in the form of an infrared signal.

When the above signal is transmitted, HDD recorder 112, DVD recorder 122 and television set 132 detects the transmission of the signal, and only HDD recorder 112 executes the specific processing based on the device code included in the signal. More specifically, HDD recorder 112 stores in its inner memory the data representing the time period and channel to be programmed, and completes the processing for the programmed recording.

When the time selected for the programmed recording comes thereafter, HDD recorder 112 starts the recording based on the set data. When the end time of the recording comes, HDD recorder 112 ends the recording. When HDD recorder 112 detects the completion of the operation based on the setting for the programmed recording, it generates the signal indicative of the completion, and transmits it in the form of an infrared signal. Remote control 102 receives the signal. More specifically, when light receiver 1006 receives the signal transmitted from HDD recorder 112, it sends the received signal to record end report detector 1026 based on the data that is included in the received signal and represents the end of the recording. Record end report detector 1026 detects the end of the recording in HDD recorder 112, and sends an instruction to end report generating unit 1028 to generate the signal for notifying of the end.

Based on this instruction, end report generating unit 1028 generates data indicating that the recording by HDD recorder 112 ended. More specifically, end report generating unit 1028 generates packet data including a header having an address of remote control 100 as well as a body having data representing the completion of the designated recording, and sends it to network transmission unit 1032. Network transmission unit 1032 transmits the packet data to Internet 190.

Storage 1030 stores a program for causing remote control 102 to execute the foregoing processing, or stores control data for causing remote control 102 to function as a device for controlling a plurality of devices. The data structure in storage 1030 will be described later.

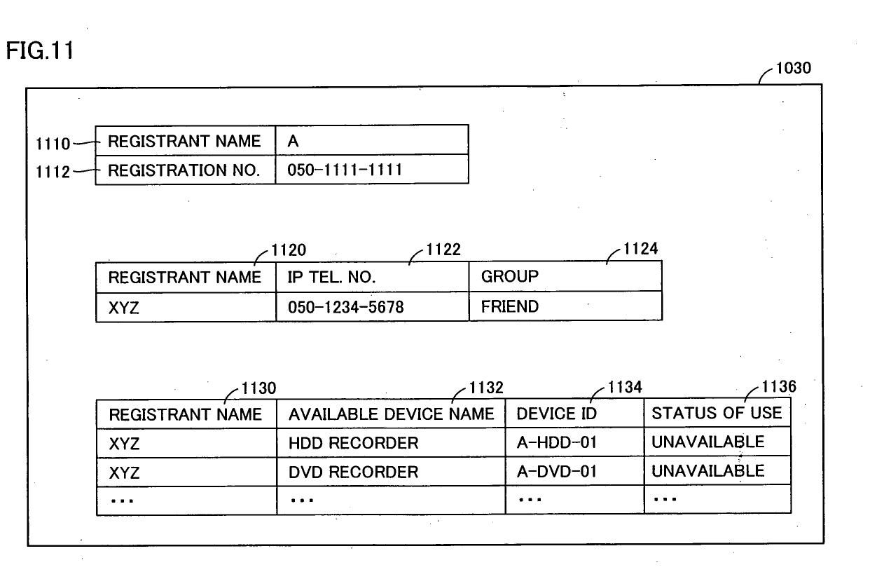

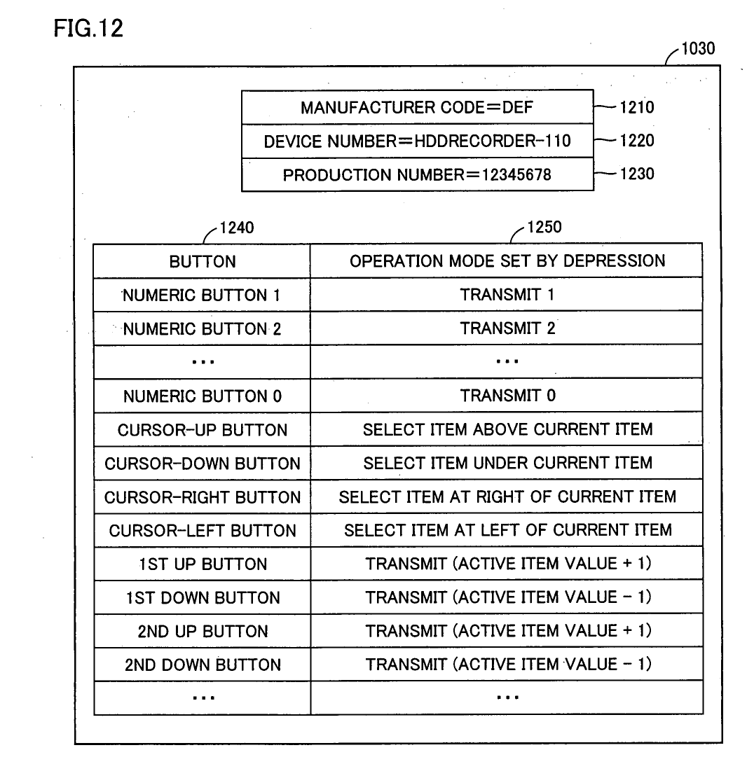

Referring to FIGS. 11 and 12, the data structure of remote control 102 will now be described. FIG. 11 conceptually illustrates a manner or form of storing data in storage 1030 provided in remote control 102. Storage 1030 is achieved, e.g., by a flash memory nonvolatilely storing the data. Storage 1030 includes a registrant name 1110 and a registration number 1112.

Registrant name 1110 is data entered as the user of remote control 102. This data is stored in storage 1030 when the user operates keys on input 1004. Registration number 1112 is a telephone number that is assigned in advance by a communication business corporation for causing remote control 102 to function as an IP telephone. Registration number 1112 is stored in storage 1030 by the user entering numbers through input 1004. Alternatively, the registration can be performed in such a manner that network receiver 1002 receives the data including the registration number, and stores it in storage 1030.

Storage 1030 includes a registrant name 1120, an IP telephone number 1122 and a group 1124. Registrant name 1120 is data for identifying a user of another remote control who is registered by the user as the party at the other end of the communications of remote control 102. For example, when the user of remote control 100 is “XYZ”, the name of the user of remote control 100 is stored as registrant name 1120. The IP telephone number of remote control 100 is stored, e.g., as “050-1234-5678”. Group 1124 represents a group containing remote control 100 that performs the communications with remote control 102. When remote control 102 performs communications with each of the plurality of remote controls, an attribute as friends or the like may be used as group 1124 so that speech communications can be performed with only the parties belonging to the specific group.

Further, storage 1030 includes a registrant name 1130, an available device name 1132, a device ID 1134 and a use situation 1136. Registrant name 1130 is the same as registrant name 1120. Available device name 1132 is data for determining the available devices on the network of each registrant. Device ID 1134 is assigned to each device, and can be identified by the remote control used for controlling the device in question. Use situation 1136 is data (e.g., a flag) representing that the device is currently available or unavailable.

FIG. 12 conceptually illustrates a form of storage of the data for controlling the device in storage 1030. Storage 1030 includes areas 1210-1250 storing data. When remote control 102 functions as a remote control for controlling HDD recorder 112, area 1210 stores the data indicating the manufacturer code of HDD recorder 112. Area 1220 stores the device number of HDD recorder 112. Area 1230 stores the production number. Area 1240 stores data for identifying buttons employed as the input in remote control 102. Area 1250 stores the data representing the operations achieved according to the operations of the respective buttons. The data stored in area 1240 associated with the data stored in area 1250. In response to depression of each button, therefore, remote control 102 generates a signal for controlling the operation of the control target device, i.e., HDD recorder 112, and transmits the generated signal in the form of an infrared signal.

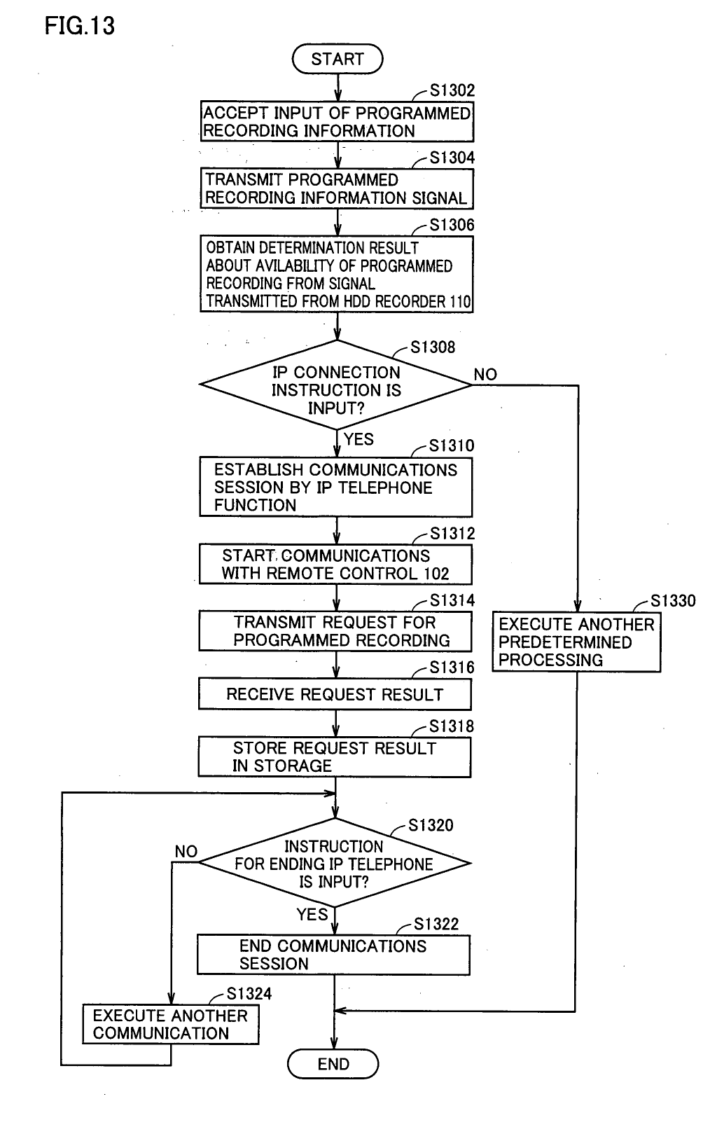

Referring to FIG. 13, a control structure of remote control 100 will now be described. FIG. 13 is a flowchart illustrating steps of the processing executed by remote control 100. Each step illustrated in FIG. 13 is achieved, e.g., by executing the program stored in storage 410.

In step S1302, controller 420 of remote control 100 accepts the input of programmed recording information based on the operation performed on button 350. In step S1304, controller 420 emits a signal relating to the programmed recording information thus entered via light emitter 330. In step S1306, controller 420 obtains a result of the determination whether the programmed recording corresponding to the programmed recording information can be performed or not, from the signal transmitted from HDD recorder 110.

In step S1308, controller 420 determines whether the instruction for the IP connection is entered or not, based on the operation on button 350. When controller 420 determines that the instruction for the IP connection is entered (YES in step S1308), the control proceeds to step S1310. Otherwise (NO in step S1308), the control proceeds to step S1330.

In step S1310, controller 420 establishes the communications session for achieving the IP telephone function. In step S1312, controller 420 starts the communications with another remote control, i.e., remote control 102 in response to the establishment of the communications session. In step S1314, controller 420 transmits a request for the programmed recording corresponding to the programmed recording information entered into remote control 102. When remote control 102 receives this request, remote control 102 performs the communications with HDD recorder 112 or another device, and performs the determination processing to determine whether the recording based on the programmed recording can be executed or not. When remote control 102 receives the result of the determination, it returns the result of the determination, using the IP telephone function that is also ensured on the party at the other end.

In step S1316, controller 420 receives the result of the request transmitted by remote control 102. In step S1318, controller 420 stores the result of the request in storage 410.

In step S1320, controller 420 determines whether the instruction for ending the IP telephone is entered or not. When controller 420 determines that the above instruction is entered (YES in step S1320), the control proceeds to step S1322. Otherwise (NO in step S1320), the control proceeds to step S1324.

In step S1322, controller 420 provides the end instruction for the communications session established with respect to remote control 102. Thereby, the communications between remote controls 100 and 102 are interrupted. In step S1324, controller 420 executes another predefined communications processing based on the operation performed on button 350. Thereafter, the control returns to step S1320. In step S1330, controller 420 executes another predetermined processing.

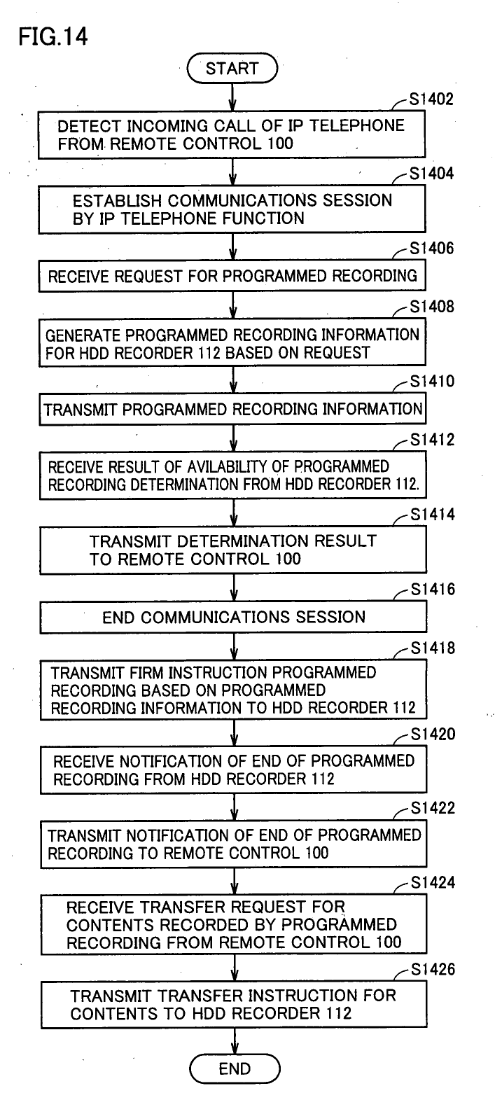

Referring to FIG. 14, the control configuration of remote control 102 will now be described. FIG. 14 is a flowchart illustrating steps of the processing executed by a CPU 1050 of remote control 102.

In step S1402, CPU 1050 of remote control 102 senses an incoming call of the IP telephone from remote control 100. In step S1404, CPU 1050 establishes the communications session by the IP telephone function. In step S1406, CPU 1050 detects the reception of the request for the programmed recording. In step S1408, CPU 1050 generates the programmed recording information for HDD recorder 112 based on the request. In step S1410, CPU 1050 transmits the programmed recording information via control signal output 1034.

In step S1412, CPU 1050 receives the determination result transmitted from HDD recorder 112 and indicating that the programmed recording is possible or not. Based on the result, CPU 1050 generates the data to be transmitted to remote control 100. In step S1414, CPU 1050 transmits the result of the determination to remote control 100 via network transmission unit 442. In step S1416, CPU 1050 ends the communications session established with respect to remote control 100.

Before the end of this session, remote control 102 receives the instruction for the programmed recording from remote control 100.

In step S1418, CPU 1050 transmits a firm instruction for the programmed recording based on the programmed recording information. When HDD recorder 112 is present in an emission range of the infrared signal transmitted from remote control 102, HDD recorder 112 can receive the signal, and executes the processing for the programmed recording included in this signal. Thereby, it becomes impossible to accept the input of another programmed recording during the same time period.

When the preselected time comes thereafter, HDD recorder 112 starts the recording of the program based on the programmed recording information. When the end time comes, HDD recorder 112 ends the recording processing.

When HDD recorder 112 detects the ending of the instructed programmed recording, it produces the data for notifying of the end, and transmits the signal of the data via light emitter 720. In step S1420, CPU 1050 receives the notification of the ending of the programmed recording transmitted from HDD recorder 112 via light receiver 1006. In step S1422, CPU 1050 converts the notification into the data for transmission, and transmits the notification of the ending of the programmed recording to remote control 100. In this operation, the communications session by the IP telephone function may be established between remote controls 100 and 102, or such a form may be employed that the communications are temporarily performed, e.g., similarly to the e-mail.

When remote control 100 receives the notification, the LED on remote control 100 indicates the ending of the programmed recording. Alternatively, a message based on the notification is prepared, and remote control 100 transmits a signal of this message to television set 130. Based on the signal, television set 130 displays character information representing the ending of the programmed recording on home network 20. When the user of remote control 100 transmits a transfer instruction for the contents of the requested programmed recording thereafter, remote control 102 receives this instruction.

In step S1424, CPU 1050 receives from remote control 100 the transfer request for the contents recorded according to the programmed recording. Based on the transfer request, CPU 1050 reads the recorded contents, and produces a signal representing the transfer instruction to be provided to network 142. In step S1426, CPU 1050 transmits an instruction signal for the transfer of the contents to HDD recorder 112 via control signal output 1034.

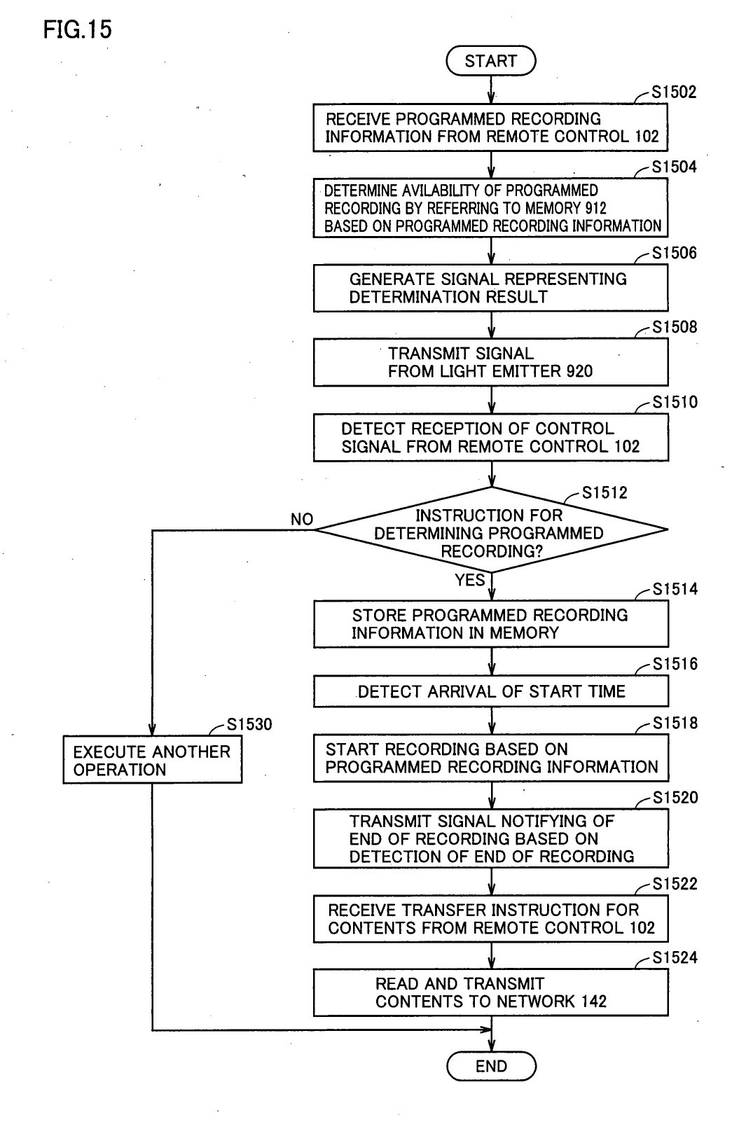

Referring to FIG. 15, description will now be given on the control configuration of HDD recorder 112. FIG. 15 is a flowchart representing steps of the processing executed by CPU 910 of HDD recorder 112.

In step S1502, CPU 910 detects reception of the programmed recording information from remote control 102 via light receiver 924. In step S1504, CPU 910 refers to memory 912 based on the programmed recording information, and determines whether the programmed recording is possible or not. In step S1506, CPU 910 produces a signal representing a result of the determination. This signal includes the data for specifying the programmed recording information and the data representing that the programmed recording is possible or not. In step S1508, CPU 910 transmits the produced signal via light emitter 920. Remote control 102 can receive the infrared signal when it is located relatively to HDD recorder 112 in a range where remote control 102 can receive the infrared signal. Remote control 102 performs the communications with remote control 100 based on the received signal, and receives the firm instruction for the programmed recording (step S1414) when the recording in HDD recorder 112 is possible.

In step S1510, CPU 910 detects the reception of the control signal provided from remote control 102. In step S1512, CPU 910 determines whether the signal is the instruction for definitizing or determining the programmed recording or not. When CPU 910 determines that the signal is the instruction for definitizing or determining the programmed recording (YES in step S1512), the control proceeds to step S1514. Otherwise (NO in step S1512), the control proceeds to step S1530. In step S1514, CPU 910 stores the programmed recording information (data and time of recording, length of recording time, channel, record mode and the like) that is included in the signal in memory 912. Thereby, setting for the programmed recording in HDD recorder 112 is completed.

In step S1516, CPU 910 detects from the signal provided from timer circuit 926 the arrival of the start time of the recording. In step S1518, CPU 910 starts the recording based on the programmed recording information stored in memory 912. In step S1520, CPU 910 detects the ending of the current recording, generates a signal notifying of the end of the recording and transmits it in the form of the infrared signal via light emitter 920.

Thereafter, communications are performed between remote controls 102 and 100, and transfer instructions for the recorded contents are transmitted between them. In step S1522, CPU 910 receives the transfer instruction (step S1426) for the contents transmitted from remote control 102. In step S1524, CPU 910 reads the contents stored in hard disk drive 940, and transmits the instruction to output selector 968 to select network 142 as the destination of the signal. Thereafter, CPU 910 controls operations of the various portions and units to transmit the contents from hard disk drive 940 to network 142.

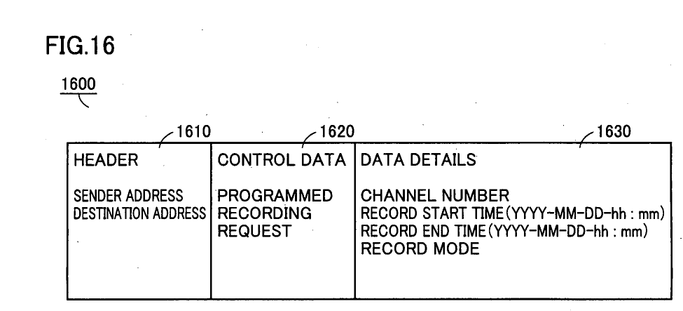

Referring to FIGS. 16 to 22, data to be transmitted will now be described. FIG. 16 conceptually illustrates a structure of a packet 1600 transmitted from remote control 100 to remote control 102.

Packet 1600 includes a header 1610, control data 1620 and data details 1630. Header 1610 includes a sender address (i.e., the address of remote control 100 on the network) and a destination address (i.e., the address of remote control 102 on the network). Control data 1620 requests the party on the other end specified by the destination address to perform operations. Data details 1630 include specific control items associated with control data 1620. For example, data details 1630 includes a channel number representing a channel to be selected, a record start time, a record end time and a mode to be used for the recording.

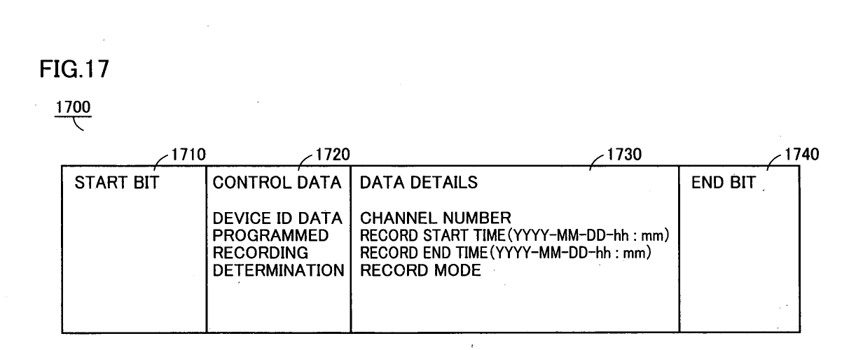

FIG. 17 conceptually shows a structure of a control signal 1700 transmitted from remote control 102. Control signal 1700 includes a start bit 1710, control data 1720, data details 1730 and an end bit 1740. Start bit 1710 represents a leading end of control signal 1700. Control data 1720 includes, e.g., device identification data for identifying a device to be controlled by control signal 1700, and specific operations (e.g., programmed recording determination or definitization) instructed to the device. Data details 1730 include specific data items associated with control data 1720. For example, data details 1730 include data representing the channel number to be selected, the record start time, the record end time and the record mode. End bit 1740 represents the ending of control signal 1700.

As can be seen from FIGS. 16 and 17, items included in control data 1620 correspond to the items included in control data 1720. The specific data items included in data details 1630 correspond to the items specifically described as data details 1730. In this manner, the control signal transmitted from remote control 100 is transmitted as packet 1600 to another remote control, i.e., remote control 102, which can likewise transmit the specific control items as control signal 1700.

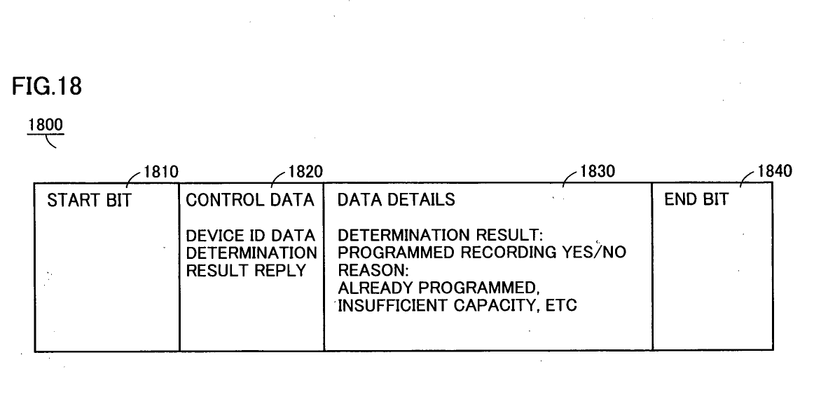

FIG. 18 conceptually illustrates a structure of a reply signal 1800 transmitted from HDD recorder 112. Reply signal 1800 includes a start bit 1810, control data 1820, data details 1830 and an end bit 1840.

Start bit 1810 represents a leading end of reply signal 1800. Control data 1820 represents an attribute of reply signal 1800. Control data 1820 includes data (e.g., the device code of HDD recorder 112) for identifying the device of the sender of reply signal 1800, data (e.g., representing “determination result reply”) representing a type of the reply result. Data details 1830 include specific data items associated with control data 1820. Data details 1830 includes, e.g., data representing the determination result and data representing reasons associated with the determination result. The determination result includes data (e.g., a flag) representing that the programmed recording is possible or not, and also includes data representing a reason of any impossibility of the programmed recording (e.g., that the same time period is already selected for another programmed recording, or that a sufficient space is not available). End bit 1840 represents the end of reply signal 1800.

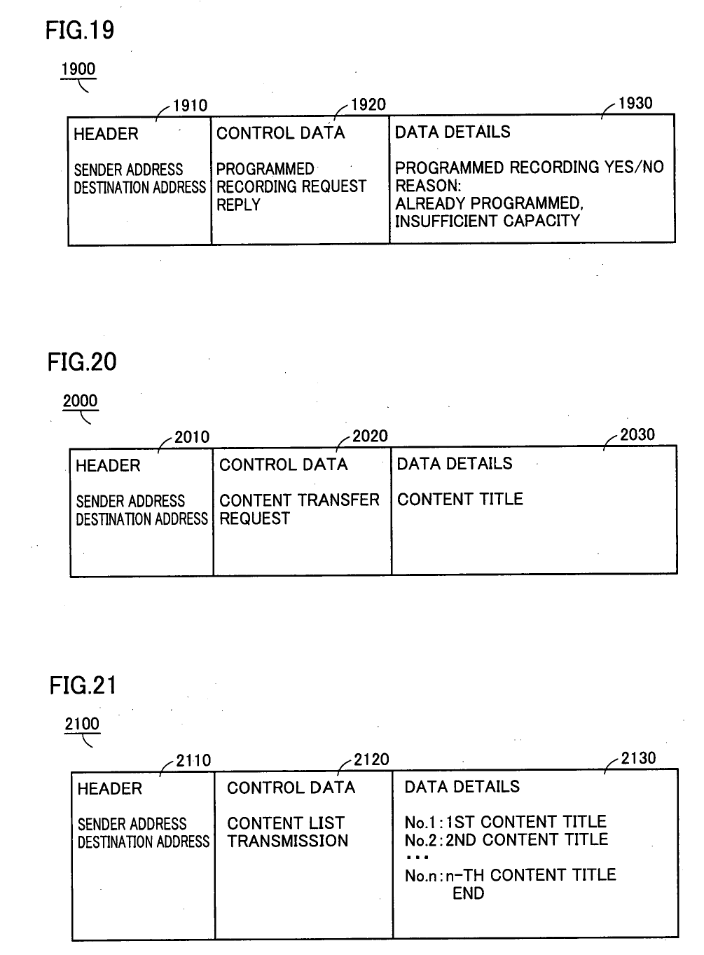

FIG. 19 conceptually illustrates a structure of a packet 1900 transmitted from remote control 102 to remote control 100. Packet 1900 includes a header 1910, control data 1920 and data details 1930.

Header 1910 includes data for specifying a sender of packet 1900 (e.g., an address of remote control 102 on the network) and an address specifying a destination of packet 1900 (e.g., an address of remote control 100 on the network). Control data 1920 corresponds to the attribute of packet 1900. Control data 1920 includes, e.g., data representing a reply to the programmed recording request. In this case, control data 1920 forms a reply to control data 1620 that is included in packet 1600 (FIG. 16) transmitted from remote control 100 to remote control 102. Data details 1930 include specific data items associated with control data 1920. Data details 1930 include data representing that the programmed recording is possible or not, and data representing a reason (overlapping of time for programmed recording or insufficient capacity) of any impossibility of the programmed recording.

As can be seen from FIGS. 18 and 19, control data 1920 included in packet 1900 corresponds to control data 1820 included in reply signal 1800. The items included in data details 1930 correspond to the items included in data details 1830. In this manner, the information included in the signal transmitted from HDD recorder 112 is transmitted over Internet 190 to remote control 100 forming another home network 10.

FIG. 20 conceptually illustrates a structure of a packet 2000 transmitted from remote control 100 to remote control 102. Packet 2000 is transmitted when the user of remote control 100 enters a transmission instruction via button 350. Packet 2000 includes a header 2010, control data 2020 and data details 2030.

Header 2010 includes data for specifying a sender of packet 2000 (e.g., an address of remote control 100 on the network) and an address specifying a destination of packet 2000 (e.g., an address of remote control 102 on the network). Control data 2020 represents the attribute of packet 2000. Control data 2020 includes, e.g., data requesting transfer of the contents recorded in HDD recorder 112. This data is generated when the user of remote control 100 operates button 350 while referring to the information displayed on display 360. Data details 2030 include specific data items associated with control data 2020. Data details 2030 includes, e.g., a title identifying the specific contents to be transferred.

When remote control 100 transmits the instruction for the programmed recording and the transfer request for the contents to remote control 102, the data stored on home network 20 is transmitted to home network 10. Consequently, by operating remote control 100, the data that is stored on another network can be transferred to network 10 containing remote control 100. Consequently, the user of remote control 100 can view the contents in question on home network 10.

<First Modification>

A first modification of the embodiment will now be described. In the embodiment that has been described, the contents themselves are transmitted. However, data transmitted between remote controls 100 and 102 is not restricted to the contents themselves. For example, titles (a content list) for specifying the stored contents may be transmitted.

Referring to FIG. 21, a packet 2100 transmitted from remote control 100 according to this modification will now be described. FIG. 21 conceptually illustrates a structure of packet 2100. Packet 2100 includes a header 2110, control data 2120 and data details 2130.

Data items included in header 2110 are the same as data items, e.g., included in header 1610 illustrated in FIG. 16. Therefore, description thereof is not repeated. Control data 2120 includes data representing an attribute of packet 2100. Control data 2120 represents, e.g., that packet 2100 is employed for transmitting the content list. Data details 2130 include specific data items associated with control data 2120. Data details 2130 include data representing titles of the respective contents of n in number.

When remote control 100 transmits packet 2100 to remote control 102, remote control 102 can determine or recognize the contents that are stored on home network 10 containing remote control 100. Likewise, a packet having substantially the same contents can be transmitted to remote controls 100 and 102, respectively. According to this manner, each user can readily obtain the information of the contents that are stored on each home network so that not only the data for the programmed recording but also the contents already held can be transferred fast.

### Second Embodiment

A second modification of the embodiment will now be described. Remote control 100 according to this modification differs from the foregoing embodiment in that remote control 100 has a function of transmitting a plurality of programmed recording information items to another remote control (e.g., remote control 102).

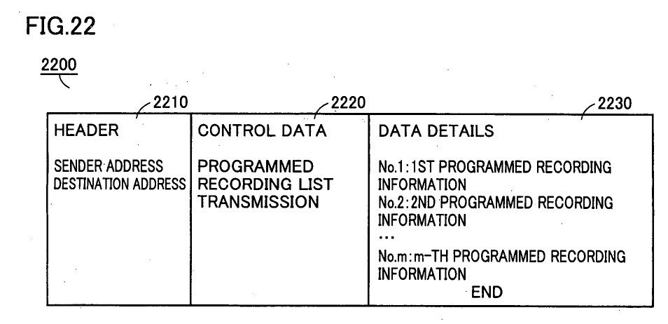

Referring to FIG. 22, description will now be given on a packet used for communications between remote controls 100 and 102 according to this modification. FIG. 22 conceptually illustrates a structure of a packet 2200 transmitted from remote control 100 to remote control 102. Packet 2200 includes a header 2210, control data 2220 and data details 2230.

The data items included in header 2210 correspond to the data items included in header 1610 illustrated in FIG. 16. Therefore, description thereof is not repeated. Control data 2220 includes data representing an attribute of packet 2200. Control data 2220 represents, e.g., that packet 2200 is employed for transmitting a list of programmed recording. Data details 2230 include specific data items associated with control data 2220. Data details 2230 includes, e.g., programmed recording information items of m in number.

When remote control 100 transmits packet 2200 having the above structure to remote control 102, remote control 102 refers to each programmed recording information item, and can determine together with a device (e.g., HDD recorder 112) forming home network 20 and having a recording function whether or not the programmed recording based on the referred programmed recording information can be executed. According to this structure, the user of remote control 100 does not transmit each programmed recording information item to remote control 102 independently of others, but can transmit a plurality of programmed recording information items at one time. Therefore, when programmed recording is to be performed for many programs, the programmed recording can be readily achieved.

According to remote control 100 of this embodiment operating as described above, when an operation is to be controlled in a device that can be directly controlled by an infrared signal, the IP telephone function is executed to perform communications with another remote control 102. Remote control 100 controls over the network the device that is controlled by an infrared signal provided from remote control 102.

This results in addition of a device that can be controlled by remote control 100. More specifically, the movie recording/reproducing devices and other devices on the home network can be mutually used. For example, when storage capacity is full in HDD recorder 110 for the programmed recording, movie reproduction or the like, remote control 100 can cause HDD recorder 112 to execute the recording or reproduction through remote control 102.

When the user is not at home, the user on the road can operate remote control 102 that controls certain home network 20, and thereby can perform communications with remote control 100 so that the user can control the device included in home network 10 of the user. The communications based on the IP telephone function provided at remote controls 100 and 102 readily achieve the above operations. This improves the convenience for the user of remote control 100.

The communications with remote controls 100 and 102 may further have a VPN (Virtual Private Network) function. In this case, gateways 150 and 152 are provided with the VPN functions, whereby the communications during the IP telephone communications can be used as a dedicated line. This restricts the use of contents to a private use.

The transmission from remote control 102 to remote control 100 may be performed according to specific timing. For example, since the lines may be relatively busy during the daytime, the transmission may performed during the nighttime, i.e., when the lines are probably not busy such that remote control 102 operates to transmit the contents from the recording/reproducing device included in home network 20 to the recording/reproducing device included in home network 10. In this case, the transmission is achieved, e.g., in the following manner.

First, each remote control stores a communication start time. The user of each remote control enters this time. Alternatively, this start time can be set to arrive when a predetermined time elapses after the end of the recording of the contents to be transmitted. When the start time arrives, each of remote controls 100 and 102 starts execution of the IP telephone function for the other. Each remote control causes each control target device, e.g., HDD recorder 110 or 112 to read the data of the transmission target contents from HDD recorder 112 and transmit them to HDD recorder 110. HDD recorder 110 changes the contents into a recordable state based on the control signal provided from remote control 100, and waits for the transmission of the data of the contents in question over the network.

When the transmission of the contents is completed thereafter, HDD recorder 112 transmits a signal representing the completion of the data transmission. Remote control 102 receives this signal. Based on this signal reception, remote control 102 generates packet data representing the completion of the content transmission, and transmits it to remote control 100.

When HDD recorder 110 completes the data writing on its record medium, HDD recorder 110 transmits a signal indicative of the completion of the storage. Remote control 100 receives this signal. When remote control 100 receives the signal from HDD recorder 110 after remote control 100 received the packet data from remote control 102, remote control 100 transmits a signal indicative of the ending of the IP telephone session. When remote control 102 ends the session in response to this signal, the communications between remote controls 100 and 102 end, and the line is released.

Thereby, the content transmission is performed during off-peak hours of the lines so that interference with other communications is prevented. Streaming distribution is smoothly performed. When the user can set the time for performing the transmission, the user can enjoy watching the contents at a desired time.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A remote control device capable of controlling a first device capable of recording and reproducing a movie, comprising:
an IP telephone unit performing communications over a network with a different remote control device connected to said network according to an Internet protocol (IP);
a storage storing access data used for connection to said different remote control device, address data for determining a position of said remote control device on said communications line, first control data for causing said first device to perform a predefined first operation, and second control data causing a second device being controllable by said different remote control device to perform a predefined second operation, said second device being capable of recording and reproducing the movie;
an infrared ray emitter emitting an instruction based on said first control data;
an input unit accepting entry of an instruction for causing said first device to perform said first operation;
a determining unit determining whether said first device can execute said first operation or not;
a session control unit establishing communications between said remote control device and said different remote control device, using said address data and said access data when said determining unit determines that said first operation cannot be executed;
a producing unit producing a request signal requesting said second device to execute, as said second operation, an operation corresponding to said first operation based on said second control data; and
a transmission controller causing said IP telephone unit to transmit said request signal to said different remote control device.

2. A remote control device for controlling a first control target device, comprising:
a communications unit performing communications over a communications line with a different remote control device connected to said communications line;
a storage storing address data for determining a position of said remote control device on said communications line, access data used for connection to said different remote control device, first control data for causing said first control target device to execute a first operation, and a second control data for causing a second control target device controllable by said different remote control device to execute a second operation;
an output unit providing an instruction based on said first control data;
an input unit accepting entry of the instruction;
a session control unit establishing communications between said remote control device and said different remote control device based on said instruction, using said address data and said access data; and
a controller controlling the operation of said second control target device based on said second control data.

3. The remote control device according to claim 2, wherein
said session control unit establishes said communications based on a protocol defining path selection in said communications line.

4. The remote control device according to claim 3, wherein
said protocol includes an Internet protocol.

5. The remote control device according to claim 2, wherein
said controller includes:
a generating unit generating a signal instructing execution of an operation of said second control target device based on said second control data; and
a transmission controller causing said communications unit to transmit said signal to said different remote control device.

6. The remote control device according to claim 5, wherein
said signal includes said access data and said second control data.

7. The remote control device according to claim 6, wherein
said input accepts entry of an instruction for causing said first control target device to execute said first operation,
said controller further includes a determining unit determining whether said first control target device can execute said first operation or not,
said session control unit establishes communications with said different remote control device when said first control target device determines that said first control target device cannot execute said first operation, and
said producing unit produces a request signal requesting said second control target device to execute an operation corresponding to said first operation as said second operation.

8. The remote control device according to claim 7, wherein
said different remote control device performs communications with said second control target device to detect completion of the operation of said second control target device based on said request signal, and transmits a result of the detection to said remote control device, and
said remote control device further includes a notifying unit notifying of the completion of the operation based on said request signal based on the signal provided from said different remote control device.

9. The remote control device according to claim 7, wherein
said first control target device includes a first device capable of recording and reproducing a movie, and said first device has control data for controlling programmed recording for the movie and transmits, to said remote control device, determination data determining based on said control data whether said first device can record the movie or not,
said second control target device includes a second device capable of recording and reproducing the movie,
said determining unit requests, based on entry of the instruction for said programmed recording, said first device to transmit said determination data, and determines based on said determination data whether said first device can perform said programmed recording or not,
said session control unit establishes communications with said different remote control device when said determining unit determines that said first device cannot execute said programmed recording, and
said generating unit generates a signal for causing said second device to execute said programmed recording, based on the data entered for said programmed recording by said first device.

10. The remote control device according to claim 7, wherein
said different remote control device inquires said remote control device whether transfer of the data recorded by said programmed recording is required or not, based on the completion of said programmed recording by said second device;
said remote control device further comprises:
an accepting unit accepting a result of determination whether the transfer of said data is required or not, and
a requesting unit transmitting to said different remote control device a request requesting the transfer of said data;
said different remote control device transmits to said second device, based on said request, a transfer instruction for transferring the data recorded by said programmed recording to said first device;
said second device transfers said data to said first device based on said transfer instruction; and
said first device records said data received from said second device.

11. The remote control device according to claim 2, wherein
said first control target device includes a first device capable of recording and reproducing a movie, said first device being capable of performing communications with said remote control device, and
said second control target device includes a second device capable of recording and reproducing the movie, said second device being capable of performing communications with said different remote control device,
said remote control device further comprising:
a first obtaining unit obtaining first information identifying contents recorded in said first device from said first device;
a second obtaining unit obtaining second information identifying contents recorded in said second device from said different remote control device;
a detector detecting missing contents recorded in said second device but not recorded in said first device, based on said first and second information; and
a requesting unit transmitting a request for transfer of said missing contents to said different remote control device; wherein
said different remote control device transmits to said second device, based on said transfer request, an instruction for reading data corresponding to said missing data and transmitting the read data to said first device; and
said second device transmits said data to said first device based on said instruction.

12. The remote control device according to claim 2, wherein
said first control target device includes a first device capable of recording and reproducing a movie, and said first device is capable of performing communications with said remote control device,
said remote control device further comprising:
an obtaining unit obtaining first list information identifying contents recorded in said first device from said first device;
an updating unit causing said obtaining unit to obtain again the information identifying said content as second list information at every predetermined time;
a calculating unit calculating information representing a difference between said first list information and said second list information; and
an update notifying unit transmitting the information representing said difference to said different remote control device.

13. The remote control device according to claim 2, wherein
said first control target device includes a first device capable of recording and reproducing a movie, and said first device is capable of performing communications with said remote control device,
said remote control device further comprising:
an obtaining unit obtaining programmed recording information representing a status of the programmed recording from said first device; and
a notifying unit transmitting said programmed recording information to said different remote control device.

14. The remote control device according to claim 2, wherein
said output includes an infrared emitter emitting an instruction in a form of an infrared signal based on said first control data.

15. The remote control device according to claim 2, wherein
said first and second operations are predefined operations.

16. The remote control device according to claim 2, wherein
said session control unit establishes communications between said communications unit and said different remote control device.

17. A system for controlling a device, comprising a first control target device, and a remote control device controlling said first control target device, wherein
said remote control device includes:
a communication unit performing communications over a communications line with a different remote control device connected to said communications line;
a storage storing address data for determining a position of said remote control device on said communications line, access data used for connection to said different remote control device, first control data for causing said first control target device to execute a first operation, and second control data for causing a second control target device controllable by said different remote control device to execute a second operation;
an output unit providing an instruction based on said first control data;
an input unit accepting entry of the instruction;
a session control unit establishing communications between said remote control device and said different remote control device based on said instruction, using said address data and said access data; and
a controller controlling the operation of said second control target device based on said second control data.
